(19) United States
(12) Patent Application Publication
(10) Pub. No.: US 2014/0076808 A1
(43) Pub. Date: Mar. 20, 2014

(54) SANITARY COLD WATER TREATMENT SYSTEMS AND METHODS

(71) Applicants: Robert Morrison, Columbia, SC (US); Vahid Gholami, Columbia, SC (US); Steven R. Gagnon, Matthews, NC (US); Tracy Barker, Irmo, SC (US); James Braun, Irmo, SC (US)

(72) Inventors: Robert Morrison, Columbia, SC (US); Vahid Gholami, Columbia, SC (US); Steven R. Gagnon, Matthews, NC (US); Tracy Barker, Irmo, SC (US); James Braun, Irmo, SC (US)

(21) Appl. No.: 13/621,897

(22) Filed: Sep. 18, 2012

(51) Int. Cl. C02F 9/00

(52) U.S. Cl. CPC C02F 9/00
USPC 210/638; 210/195.2; 210/652

(57) ABSTRACT

A system and method for purifying and recycling cold wastewater is provided. Contaminated wastewater is supplied at a temperature no greater than 45° F. through an ultrafilter. The wastewater is fed through a reverse osmosis filter unit. Clean water is reused whereas reject is sent to disposal. Cold temperatures are preferably maintained throughout the treatment process.

### FIELD OF THE INVENTION

The present invention relates generally to systems and methods that purify and recycle waste water.

### BACKGROUND OF THE INVENTION

Many cleaning and/or washing processes that utilize cold water to reduce the capacity for bacterial growth will build up contaminants in the water over time, making the water unavailable for reuse. Conventional treatment methods utilize biological degradation to reduce the concentration of contaminants in the water. For many industrial processes, it is more cost effective to discharge the water to the public sewer system. Even before such discharge, however, it is often necessary to reduce the level of biochemical oxygen demand (BOD) in the water before it can be accepted by the sewer system. In addition, the sewer authority will generally charge the water user for the amount of wastewater that it receives. Accordingly, efforts have been made to create cost-effective wastewater treatment systems that may be adapted to the particular water-based processes. Such treatment and reuse is important to limit costs and for reducing water consumption.

### SUMMARY OF THE INVENTION

According to an aspect, the present invention provides a system for purifying and recycling cold wastewater. The system comprises an ultrafiltration storage vessel receiving a cold wastewater maintained at a temperature no greater than 45° F. comprising an ultrafiltration inlet, an ultrafiltration outlet and an ultrafilter fluidly connected between the ultrafiltration inlet and the ultrafiltration outlet and wherein the ultrafiltration inlet is in fluid communication with an initial supply of the cold wastewater. The system also comprises a first reverse osmosis filter comprising a first reverse osmosis filter inlet and a first reverse osmosis filter outlet and wherein the first reverse osmosis filter inlet is in fluid communication with the ultrafiltration outlet. The system further comprises a second reverse osmosis filter comprising a second reverse osmosis filter inlet and a second reverse osmosis filter outlet and wherein the second reverse osmosis filter outlet is in fluid communication with a return line.

According to another aspect, the present invention also provides a method for purifying and recycling cold wastewater. The method comprises supplying an amount of contaminated wastewater at a temperature no greater than 45° F. through an ultrafilter and feeding the contaminated wastewater fed through the ultrafilter through a reverse osmosis filter.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a block diagram illustrating the steps of an embodiment of a method of the present invention; and

FIG. 2 is a schematic illustrating an embodiment of a system of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention relates to systems and methods for the purification and reuse of wastewater, such as wastewater created during industrial processes that utilize chilled or cold water. For example, the present invention may be utilized in connection with the washing and cleaning of various food items, including fruits and vegetables, following their arrival at a processing plant. As it is known, various fruits and vegetables, for example tomatoes and/or lettuce, which will be used in a variety of food end products must first be properly washed and cleaned before they are further processed. Utilizing the systems and methods of the present invention, the wastewater, after such washing and cleaning has occurred, may be purified and recycled for reuse in the washing and cleaning process. The systems and methods of the present invention preferably include a filtration stage and a reverse osmosis stage performed at cold temperature. With the present invention, processes that utilize cold water may be performed with substantial cost savings to the user in water consumption and environmental benefits

As indicated above, the present invention will typically be utilized in connection with processes that require cold water, such as the larger scale washing of produce. In some embodiments, the temperature of the water may be less than 45° F. or, in additional embodiments, the temperature of the water may be less than 38° F. throughout the treatment process. As noted, such wastewater may contain Biochemical Oxygen Demand (BOD) and/or other pollutants from the washing/cleaning process that must be removed before it can be utilized again or disposed of properly. Wastewater treatment systems of the prior art have brought the water to high temperatures to achieve biological degradation. This is in distinct contrast to embodiments of the present invention, which maintain a sanitary environment to remove completely BOD and other pollutants from the waste stream without introducing heat or any biological process.

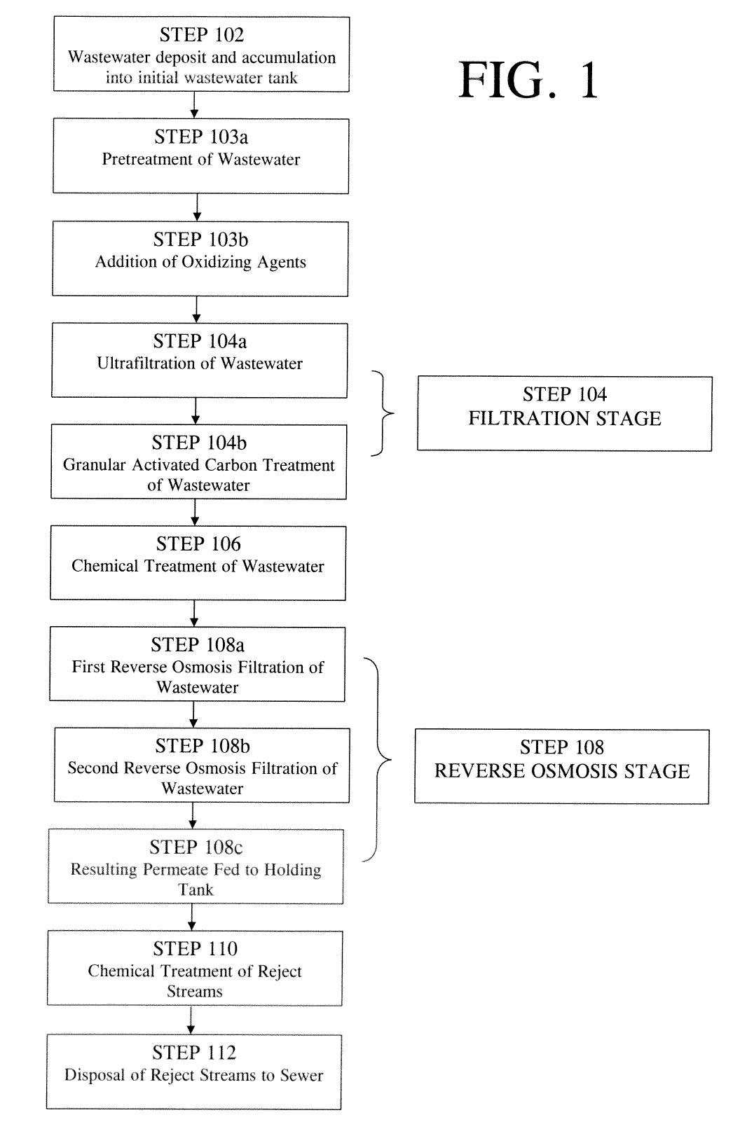

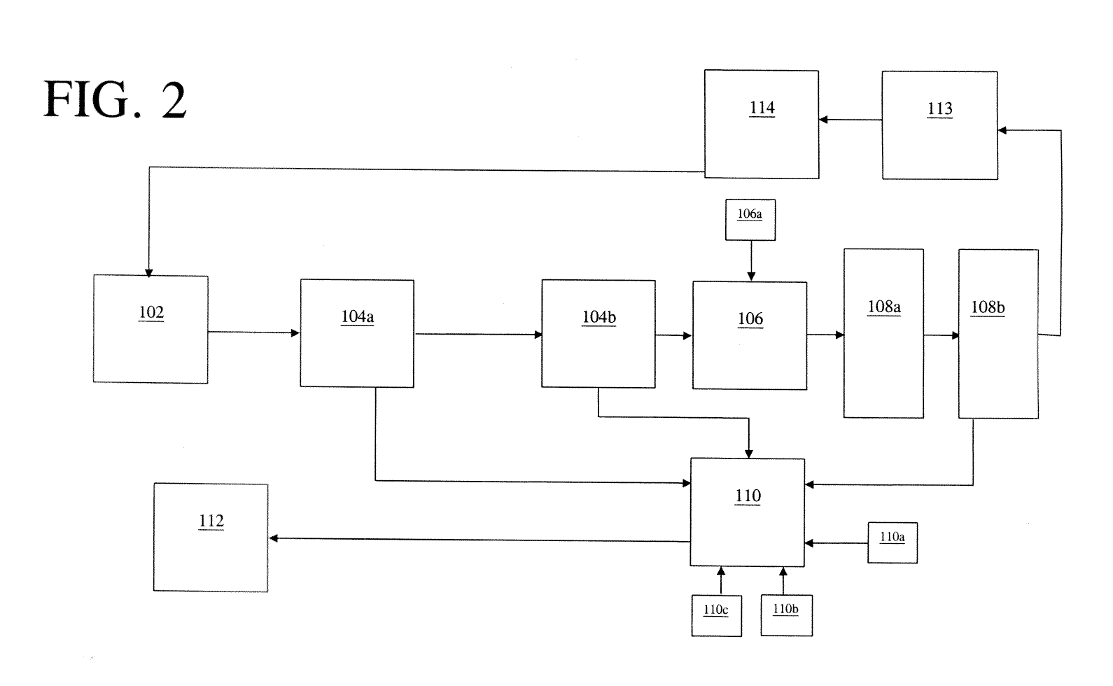

Referring now to FIGS. 1 and 2, the water utilized in such cold-water processes may be deposited and accumulated into an initial wastewater tank or other storage area 102 following its use (STEP 102). Systems and methods of the present invention are preferably scalable such that they may be adapted to the particular size of the industrial process with which they are utilized. For example, the initial wastewater tank 102 may be of any sufficient size to properly house the wastewater that results from a cold-water washing process. In addition, the apparatuses used in connection with the filtration stage and the reverse osmosis stage may be of any size to sufficiently adapt to the flow of the wastewater streams.

Depending on the contaminants in the wastewater, a standard pretreatment system, including screening, dissolved air flotation, or primary clarification may be utilized to allow the downstream filtration processes to work more efficiently (STEP 103a). In addition, in some embodiments of the present invention, the wastewater may be treated with an oxidizing agent, including chlorine, hydrogen peroxide, or others (STEP 103b). However, in embodiments of the present invention where the wastewater is already sufficiently chlorinated (i.e. in many food cleaning processes), STEP 103b may not be necessary.

Once the wastewater in the initial wastewater tank 102 has reached a threshold volume (level), the wastewater is fed to a filtration stage of the present invention (STEP 104). The threshold level of wastewater may be determined by the user's specifications and may depend on the size of the initial wastewater tank or the urgency in which the wastewater is needed to be purified. As one skilled in the art will appreciate, the feed of wastewater to the various stages, including the feed of the wastewater to the filtration stage, may be accomplished through a variety of pumps that are known and utilized in the art for the movement of wastewater. In addition, the wastewater out of the initial wastewater tank, as well as to each of the stages of the present invention, may be fed at various flow rates depending on the user's specifications. For example, in some embodiments a flow rate of between about 150 gallons per minute (gpm) and about 500 gpm may be used.

The filtration stage 104 aids in separating the soluble solids in the wastewater from the solid particles which remain in suspension in the wastewater. Such solid particles adversely affect the water quality and, therefore, must be removed such that the wastewater may be reused.

Ultrafiltration is a type of membrane filtration in which hydrostatic pressure is utilized to force the wastewater against a semi-permeable membrane. Accordingly, the suspended solid particles mentioned above that are of a very small threshold size may be retained in an ultrafilter vessel of the ultrafiltration step. Thus, virtually all non-soluble pollutants are removed in this manner. The more purified water and any soluble pollutants (or particles too small for ultrafiltration) are allowed to pass through the semi-permeable membrane.

The ultrafilter of the ultrafiltration step may be located in an ultrafiltration vessel 104a (FIG. 2) of suitable size. Ultrafiltration vessel 104a may be further equipped with a drain that is in fluid communication with an equalization (EQ) tank 110 to which the reject or contaminated streams of the treatment process are fed. For example, the materials rejected by the ultrafilter of the present invention may be fed through a backwashing process to the EQ tank for further treatment prior to the materials' disposal.

Ultrafilters that include semi-permeable membranes of various pore sizes may be utilized in connection with the systems and methods of the present invention. For example, in some embodiments, a semi-permeable membrane having a pore size of less than 0.05 μm may be utilized. In further embodiments, a semi-permeable membrane having a pore size of less than 0.01 μm may be utilized. In addition, as indicated above, the ultrafiltration step utilizes hydrostatic pressure to force the wastewater through the semi-permeable membrane of the ultrafilter. Depending on the particular ultrafilter utilized in the present invention, the ultrafilter may include a suction pressure between about −10 and about 0 psi. In further embodiments, when utilizing ultrafilters that rely on positive pressure, the pressure of the ultrafilter may be between about 30 psi and about 125 psi. Examples of ultrafilters that may be utilized in connection with the present invention include those manufactured by Trisep Corporation and which utilize the tradename SpiraSep. The particular installation and the specifications of the user may dictate the necessary ultrafilter semi-permeable membrane and associated pressure used.

As indicated above, the filtration stage of the present invention may further include a GAC treatment step (STEP 104b) following the ultrafiltration step. GAC vessels use adsorption to purify liquids and gasses where organic material found in the wastewater is trapped within the porous surface of the granular particles of the GAC filter. The GAC treatment step may be utilized to effectively remove the oxidizing agents that are present in the wastewater from the underlying cold water process or from STEP 103b, as discussed above, to ensure that the reverse osmosis stage may be effective in further purifying the wastewater. Oxidizing agents should not be passed through the reverse osmosis stage because such agents may attack and degrade the membranes of reverse osmosis systems. However, the chlorinated wastewater should not be passed through the reverse osmosis stage because chlorine may attack and degrade the membranes of reverse osmosis systems. Accordingly, the GAC treatment step may provide protection to the reverse osmosis systems to ensure there efficacy.

In order to initiate the GAC treatment step, the wastewater that is permeated through the ultrafilter is fed by way of a pump or other known process to a GAC vessel 104b and through a GAC bed that is housed within the GAC vessel 104b. GAC filters that are used in connection with the present invention may be of any size to properly and effectively remove at least a portion of the oxidizing agent that may be found in the wastewater. Although the size of the vessel may vary, the flux rate of the wastewater through the GAC vessel may be such that it is between about 1 gallon per minute (gpm)/ft² and about 10 gpm/ft². In additional embodiments, the flux rate of the wastewater through the GAC vessel may be between about 4 gpm/ft² and about 6 gpm/ft².

In some embodiments, to ensure that the GAC bed is properly maintained to meet the process requirements, the GAC vessel 104b may use a backwashing cycle after it reaches a threshold pressure drop. In the backwashing process, the flow of the wastewater is reversed allowing the granular particles of the GAC vessel to be reconfigured to their original configuration. Following such backwashing process, the wastewater may be sent through the GAC bed again or, as in the case of the ultrafilter, may exit the GAC vessel 104b through a drain and allowed to flow to the EQ tank 110 for further processing before disposal.

The threshold pressure at which the GAC bed should be backwashed varies with the particular size and specifications of the installation. For example, in some embodiments, the threshold pressure required for the commencing of the backwashing process is between about 20 psi and about 25 psi.

In some embodiments, following the filtration stage and prior to the reverse osmosis stage, the resulting wastewater may be further chemically treated (STEP 106). In such embodiments, the chemical treatment may be to ensure removal of any remaining oxidizing agents and/or may include the addition of biocide materials to neutralize remaining bacteria in the wastewater. In such embodiments, the wastewater, following passage through the filtration stage, may be fed to a chemical treatment vessel 106 by the use of a pump.

In embodiments where the wastewater is treated for the removal of oxidizing agents, a mixture of water and sodium bisulfate 106a (or other dechlorination chemical), where the sodium bisulfate is between about 25% and about 50% of the weight of the mixture, may be injected into the chemical treatment vessel 106 as the wastewater is allowed to pass. For example, such mixture may be added in a continuous manner at about 0.5 to about 5 gallons per hour. In other embodiments, the chemical treatment vessel may include a sensor to detect the amount of chlorine in the wastewater such that the dechlorination mixture may be fed at alternating flow rates based on the chlorine content of the wastewater at a given time.

Following the optional chemical treatment, the water passes to a reverse osmosis stage (STEP 108). Reverse osmosis is a membrane-technology filtration method that removes molecules from solutions by applying pressure to the solution when it is on one side of a semi-permeable membrane. In particular, impurities found in the wastewater remain on the pressurized side of the membrane while purified water is passed to the opposite side of the semi-permeable membrane in the filter. Unlike the filtration stage, which relies on the pore size of the semi-permeable membrane to affect filtration, reverse osmosis is a diffusive mechanism that is dependent on solute concentration, pressure, and water flux rate. As a result, the reverse osmosis unit serves to completely remove the soluble pollutants that remain in the wastewater to this point. It may be desirable to position one or more media filters, such as a cartridge filter, immediately upstream of the reverse osmosis unit.

Preferably, a multi-step process is employed where the wastewater is sent through the reverse osmosis filter twice to ensure proper filtration. During the reverse osmosis stage, the wastewater is fed to a first reverse osmosis unit 108a (STEP 108a) and then to a second reverse osmosis unit 108b (STEP 108b) from a feed of wastewater in fluid communication with the optional chemical treatment vessel 106. After the wastewater has been fed to first reverse osmosis unit, the resulting permeate of the first reverse osmosis unit 108a is fed to the second reverse osmosis unit 108b. Following the flow through second reverse osmosis unit 108b, the reject of second reverse osmosis unit 108b is fed to the EQ tank 110 and the resulting permeate is fed to a holding tank 113 (STEP 108c) where it may be used again in the cold-water process 114 with which the illustrated system is utilized.

The reverse osmosis unit of the present invention may be run at any pressure suitable for proper filtration of the wastewater. For example, in some embodiments, the pressure applied to the wastewater stream by the reverse osmosis filter may be between about 200 psi and about 300 psi. In other embodiments of the present invention, the pressure applied to the wastewater stream by the reverse osmosis filter may be between about 300 psi and about 400 psi.

Although the present invention has been described with the wastewater entering the reverse osmosis unit twice, in other embodiments of the invention, the wastewater may be passed through the reverse osmosis unit any number of times to ensure the effective and efficient re oval of the remaining BODs and other contaminants of the wastewater. For example, in some embodiments, the present invention may utilize one, three, four or more passes of the wastewater through the reverse osmosis filter prior to returning to the cold-water process.

As the EQ tank 110 continually receives rejected wastewater from the ultrafilter tank 104a, the GAC vessel 104b and the reverse osmosis unit 108a, the contents of the EQ tank 110 may be chemically treated to neutralize any harmful contaminants before disposal (STEP 110). For example, in an embodiment of the present invention, the EQ tank may be fluidly connected to a supply of sodium bisulfate 110a to further dechlorinate the reject wastewater. In addition, feed streams containing nitrogen in the form of urea 110b and phosphorus in the form of phosphoric acid 110c may be added to the EQ tank 110 to aid in the biodegradation of the resulting reject streams. For example, a feed stream of between about 0.1 and about 2 gallons per hour with a urea content between about 25% and about 65% by weight urea may be added. Additionally, in such embodiments, a feed stream of between about 0.5 and about 5 gallons per hour with a phosphoric acid content of between about 75% and about 100% by weight phosphoric acid may be added. However, the feed streams mentioned above may be altered, in the particular chemicals used and the amounts in which they are fed, to properly adapt to the particular installation for proper decontamination before disposal.

Following chemical treatment of the accumulated reject streams in the EQ tank 110, the resulting wastewater may be exited from the EQ tank for disposal in a sewer 112 or other system for disposal (STEP 112). However, in further embodiments of the invention, the wastewater exiting the EQ tank may be further treated. For example, in some embodiments, the wastewater may be heated to a temperature above 65° F. such that contaminants and bacteria found in the wastewater may be neutralized and killed. In additional embodiments, the resulting wastewater streams may be passed through a trickling filter and/or a clarifier before being disposed of. Such a trickling filter, which one skilled in the art should be able to select based on the disclosure herein, functions to biologically treat the RO concentrate. Any combination of known treatments may be utilized such that the wastewater is in a proper form (based on governmental or internal regulations) prior to its disposal.

The systems and methods of the present invention allow for the recycling and reuse of cold water in processes that utilize the same. In accordance with the present invention, such improved systems and methods in cold water situations may provide reuse rates between about 75 and 95%. This achieves substantial financial savings to the users of such cold-water processes and can alleviate many environmental concerns related to excessive water consumption.

While preferred embodiments have been described above, many modifications and variations are possible. These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A system for purifying and recycling cold wastewater, the system comprising:
an ultrafiltration vessel receiving a cold wastewater maintained at a temperature no greater than 45° F. comprising an ultrafiltration inlet, an ultrafiltration outlet and an ultrafilter fluidly connected between the ultrafiltration inlet and the ultrafiltration outlet and wherein the ultrafiltration inlet is in fluid communication with an initial supply of the cold wastewater;
a first reverse osmosis filter comprising a first reverse osmosis filter inlet and a first reverse osmosis filter outlet and wherein the first reverse osmosis filter inlet is in fluid communication with the ultrafiltration outlet; and
a second reverse osmosis filter comprising a second reverse osmosis filter inlet and a second reverse osmosis filter outlet and wherein the second reverse osmosis filter outlet is in fluid communication with a return line.

2. The system of claim 1, wherein the system further comprises a granular activated carbon filter vessel comprising a granular activated carbon inlet, a granular activated carbon filter, and a granular activated carbon filter fluidly connected between the granular activated carbon filter inlet and the granular activated carbon outlet and wherein the granular activated carbon inlet is in fluid communication with the ultrafiltration outlet and the granular activated carbon inlet is in fluid communication with the first reverse osmosis filter inlet.

3. The system of claim 1, wherein the cold wastewater is maintained at a temperature no greater than 38° F.

4. The system of claim 1, wherein the system further comprises a chemical treatment vessel comprising a chemical treatment inlet and a chemical treatment outlet and wherein the chemical treatment inlet is in fluid communication with the ultrafiltration outlet and the chemical treatment outlet is in fluid communication with the first reverse osmosis filter inlet.

5. The system of claim 1, wherein the system further comprises an equalization tank comprising an equalization inlet and equalization outlet.

6. The system of claim 5, wherein the ultrafiltration vessel further comprises a reject outlet that is in fluid communication with the equalization inlet.

7. The system of claim 5, wherein the second reverse osmosis filter comprises a reject outlet that is in fluid communication with the equalization tank.

8. The system of claim 5, wherein the equalization outlet is in fluid communication with a sewer system.

9. The system of claim 8, wherein the system further comprises a trickling filter comprising a trickling filter inlet and a trickling filter outlet, wherein the tricking filter inlet is in fluid communication with the equalization outlet and the tricking filter outlet is in fluid communication with the sewer system.

10. A method for purifying and recycling cold wastewater, the method comprising:
feeding contaminated wastewater maintained at a temperature no greater than 45° F. through an ultrafilter; and
feeding the contaminated wastewater fed through the ultrafilter through a reverse osmosis filter.

11. The method of claim 10, wherein the method further comprises feeding the contaminated wastewater fed through the ultrafilter through a granular activated carbon filter prior to feeding the contaminated wastewater through the reverse osmosis filter.

12. The method of claim 10, wherein the amount of contaminated wastewater is at a temperature no greater than 38° F.

13. The method of claim 10, wherein the method further comprises chemically treating the contaminated wastewater prior to feeding the contaminated wastewater through the reverse osmosis filter.

14. The method of claim 13, wherein the method of chemically treating the contaminated wastewater comprises adding dechlorination elements to the contaminated wastewater.

15. The method of claim 10, wherein the contaminated wastewater is fed through the reverse osmosis filter a second time.

16. The method of claim 11, wherein the method further comprises feeding a reject stream from each of the ultrafilter, the granular activated carbon filter, and the reverse osmosis filter to an equalization storage area.

17. The method of claim 16, wherein the method further comprises adding dechlorination elements to the contaminated wastewater

18. The method of claim 16, wherein the method further comprises adding urea to the equalization storage area.

19. A method for purifying and recycling cold wastewater, the method comprising the following steps in the following order:
feeding contaminated wastewater at a temperature no greater than 45° F. through an ultrafilter;
feeding the contaminated wastewater fed through the ultrafilter through a granular activated carbon filter;
adding dechlorination elements to the contaminated wastewater; and
feeding the contaminated wastewater fed through the granular activated carbon filter through a reverse osmosis filter.
